(19) United States
(12) Patent Application Publication
(10) Pub. No.: US 2010/0000798 A1
(43) Pub. Date: Jan. 7, 2010

(54) METHOD TO REDUCE CARBIDE EROSION OF PDC CUTTER

(76) Inventor: Suresh G. Patel, The Woodlands, TX (US)

Correspondence Address: TRASKBRITT, P.C., P.O. BOX 2550, SALT LAKE CITY, UT, 84110, US

(21) Appl. No.: 12/489,715

(22) Filed: Jun. 23, 2009

Related U.S. Application Data
(60) Provisional application No. 61/077,752, filed on Jul. 2, 2008.

(51) Int. Cl. E21B 10/46; E21B 10/42; E21B 10/54; E21B 10/56; B23B 27/18; B23K 31/02

(52) U.S. Cl. 175/426; 175/425; 408/145; 228/122.1

(57) ABSTRACT

An abrasive wear-resistant material includes a matrix and sintered and cast tungsten carbide granules. A device for use in drilling subterranean formations includes a first structure secured to a second structure with a bonding material. An abrasive wear-resistant material covers the bonding material. The first structure may include a drill bit body and the second structure may include a cutting element. A method for applying an abrasive wear-resistant material to a drill bit includes providing a bit, mixing sintered and cast tungsten carbide granules in a matrix material to provide a pre-application material, heating the pre-application material to melt the matrix material, applying the pre-application material to the bit, and solidifying the material. A method for securing a cutting element to a bit body includes providing an abrasive wear-resistant material to a surface of a drill bit that covers a brazing alloy disposed between the cutting element and the bit body.

### CROSS-REFERENCE TO RELATED APPLICATIONS

This application claims the benefit of U.S. provisional patent application Ser. No. 61/077,752, filed Jul. 2, 2008, which is incorporated herein in its entirety. This application is also related to application Ser. No. 11/223,215, which was filed Sep. 9, 2005, and is currently pending, the contents of which are incorporated herein in their entirety.

### TECHNICAL FIELD

The embodiments herein generally relate to earth-boring drill bits and other tools that may be used to drill subterranean formations having abrasive, wear-resistant hardfacing materials that may be used on surfaces of the cutting elements of such earth-boring drill bits. The embodiments herein also relate to methods for applying abrasive wear-resistant hardfacing materials to surfaces of earth-boring drill bits.

### BACKGROUND

A typical fixed-cutter, or “drag,” rotary drill bit for drilling subterranean formations includes a bit body having a face region thereon carrying cutting elements for cutting into an earth formation. The bit body may be secured to a hardened steel shank having a threaded pin connection for attaching the drill bit to a drill string that includes tubular pipe segments coupled end-to-end between the drill bit and other drilling equipment. Equipment such as a rotary table or top drive may be used for rotating the tubular pipe and drill bit. Alternatively, the shank may be coupled directly to the drive shaft of a down-hole motor to rotate the drill bit.

Typically, the bit body of a drill bit is formed from steel or a combination of a steel blank embedded in a matrix material that includes hard particulate material, such as tungsten carbide, infiltrated with a binder material such as a copper alloy. A steel shank may be secured to the bit body after the bit body has been formed. Structural features may be provided at selected locations on and in the bit body to facilitate the drilling process. Such structural features may include, for example, radially and longitudinally extending blades, cutting element pockets, ridges, lands, nozzle displacements, and drilling fluid courses and passages. The cutting elements generally are secured within pockets that are machined into blades located on the face region of the bit body.

Generally, the cutting elements of a fixed-cutter type drill bit each include a cutting surface comprising a hard, super-abrasive material such as mutually bound particles of polycrystalline diamond. Such “polycrystalline diamond compact” (PDC) cutters have been employed on fixed-cutter rotary drill bits in the oil and gas well drilling industries for several decades.

### BRIEF SUMMARY

The embodiments herein include an abrasive wear-resistant material that includes a matrix material and either cast tungsten carbide, sintered tungsten carbide, or macrocrystalline tungsten carbide or a mixture thereof applied to the cutting elements of a fixed-cutter type drill bit.

The features, advantages, and alternative aspects of the embodiments herein will be apparent to those skilled in the art from a consideration of the following detailed description considered in combination with the accompanying drawings.

### BRIEF DESCRIPTION OF THE DRAWINGS

While the specification concludes with claims particularly pointing out and distinctly claiming that which is regarded as the embodiments herein, the advantages of these embodiments may be more readily ascertained from the following description of the embodiments when read in conjunction with the accompanying drawings in which:

FIG. 1 is a perspective view of a conventional rotary drill bit that includes cutting elements;

FIG. 2 is an enlarged view of a cutting element of the conventional rotary drill bit shown in FIG. 1;

FIG. 3A is an enlarged view of a cutting element of a drill bit that embodies teachings of the present invention;

FIG. 3B is a lateral cross-sectional view of the cutting element shown in FIG. 3A taken along section line 3B-3B therein;

FIG. 3C is a longitudinal cross-sectional view of the cutting element shown in FIG. 3A taken along section line 3C-3C therein;

FIG. 4A is a lateral cross-sectional view like that of FIG. 3B illustrating another cutting element of a drill bit that embodies teachings of the present invention; and

FIG. 4B is a longitudinal cross-sectional view of the cutting element shown in FIG. 4A.

### DETAILED DESCRIPTION

The present embodiments herein include a rotary drill bit for drilling subterranean formations that includes a bit body and at least one cutting element secured to the bit body along an interface. As used herein, the term “drill bit” includes and encompasses drilling tools of any configuration, including core bits, eccentric bits, bicenter bits, reamers, mills, drag bits, roller cone bits, and other such structures known in the art. A brazing alloy is disposed between the bit body and the at least one cutting element at the interface and secures the at least one cutting element to the bit body. An abrasive wear-resistant material that includes a matrix having either cast tungsten carbide, sintered tungsten carbide, or macrocrystalline tungsten carbide, or a mixture of thereof is applied to portions of cutters thereon.

In another aspect, the present embodiments herein include a method for securing a cutting element to a bit body of a rotary drill bit. The method includes providing a rotary drill bit including a bit body having an outer surface including a pocket therein that is configured to receive a cutting element, and positioning a cutting element within the pocket. A brazing alloy is provided, melted, and applied to adjacent surfaces of the cutting element and the outer surface of the bit body within the pocket defining an interface therebetween and solidified. An abrasive wear-resistant material is applied to a surface of the drill bit. At least a continuous portion of the abrasive wear-resistant material is bonded to a surface of the cutting element and may be bonded to a portion of the outer surface of the bit body. The continuous portion extends over at least the interface between the cutting element and the outer surface of the bit body and covers the brazing alloy.

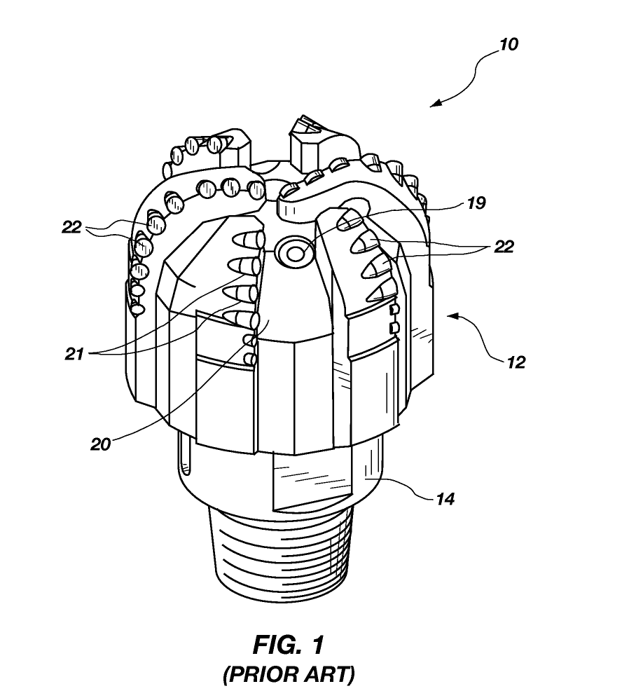

FIG. 1 illustrates a conventional fixed-cutter rotary drill bit 10 generally according to the description above. The rotary drill bit 10 includes a bit body 12 that is coupled to a steel shank 14. A bore (not shown) is formed longitudinally through a portion of the rotary drill bit 10 for communicating drilling fluid to a face 20 of the rotary drill bit 10 via nozzles 19 during drilling operations. Cutting elements 22 (typically polycrystalline diamond compact (PDC) cutting elements) generally are bonded to the bit face 20 of the bit body 12 by methods such as brazing, adhesive bonding, or mechanical affixation.

A rotary drill bit 10 may be used numerous times to perform successive drilling operations during which the surfaces of the bit body 12 and cutting elements 22 may be subjected to extreme forces and stresses as the cutting elements 22 of the rotary drill bit 10 shear away the underlying earth formation. These extreme forces and stresses cause the cutting elements 22 and the surfaces of the bit body 12 to wear. Eventually, the cutting elements 22 and the surfaces of the bit body 12 may wear to an extent at which the rotary drill bit 10 is no longer suitable for use.

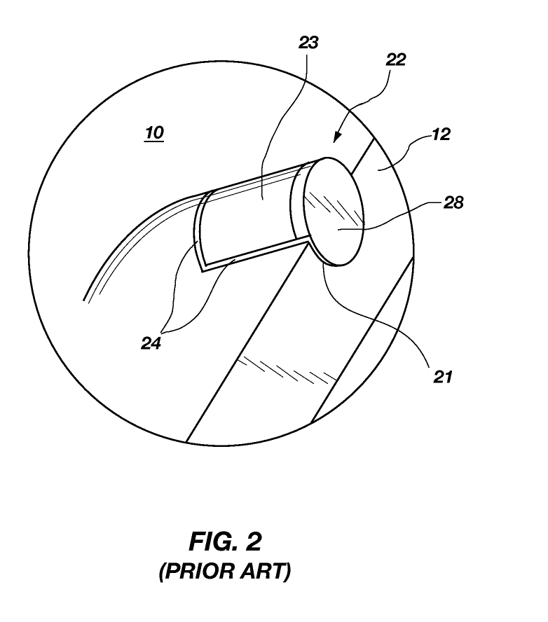

FIG. 2 is an enlarged view of a conventional PDC cutting element 22 like those shown in FIG. 1 secured to the bit body 12. Cutting elements 22 generally are not integrally formed with the bit body 12. Typically, the cutting elements 22 are fabricated separately from the bit body 12 and secured within pockets 21 formed in the outer surface of the bit body 12. A bonding material 24 such as an adhesive or, more typically, a braze alloy may be used to secure the cutting elements 22 to the bit body 12 as previously discussed herein. Furthermore, if the cutting element 22 is a PDC cutter, the cutting element 22 may include a polycrystalline diamond compact table 28 secured to a cutting element body or substrate 23, which may be unitary or comprise two components bound together.

The bonding material 24 typically is much less resistant to wear than are other portions and surfaces of the rotary drill bit 10 and of cutting elements 22. During use, small vugs, voids and other defects may be formed in exposed surfaces of the bonding material 24 due to wear. Solids-laden drilling fluids and formation debris generated during the drilling process may further erode, abrade and enlarge the small vugs and voids in the bonding material 24. The entire cutting element 22 may separate from the drill bit body 12 during a drilling operation if enough bonding material 24 is removed. Loss of a cutting element 22 during a drilling operation can lead to rapid wear of other cutting elements and catastrophic failure of the entire rotary drill bit 10. Therefore, there is a need in the art for an effective method for preventing the loss of cutting elements during drilling operations.

The materials of an ideal drill bit must be extremely hard to efficiently shear away the underlying earth formations without excessive wear. Due to the extreme forces and stresses to which drill bits are subjected during drilling operations, the materials of an ideal drill bit must simultaneously exhibit high fracture toughness. In practicality, however, materials that exhibit extremely high hardness tend to be relatively brittle and do not exhibit high fracture toughness, while materials exhibiting high fracture toughness tend to be relatively soft and do not exhibit high hardness. As a result, a compromise must be made between hardness and fracture toughness when selecting materials for use in drill bits.

In an effort to simultaneously improve both the hardness and fracture toughness of earth-boring drill bits, composite materials have been applied to the surfaces of drill bits that are subjected to extreme wear. These composite materials are often referred to as “hardfacing” materials and typically include at least one phase that exhibits relatively high hardness and another phase that exhibits relatively high fracture toughness.

Typically, hardfacing material includes tungsten carbide particles substantially randomly dispersed throughout an iron-based matrix material or other suitable material. The tungsten carbide particles exhibit relatively high hardness, while the matrix material exhibits relatively high fracture toughness.

Tungsten carbide particles used in hardfacing materials may comprise one or more of cast tungsten carbide particles, sintered tungsten carbide particles, and macrocrystalline tungsten carbide particles. The tungsten carbide system includes two stoichiometric compounds, WC and W₂C, with a continuous range of compositions therebetween. Cast tungsten carbide generally includes a eutectic mixture of the WC and W₂C compounds. Sintered tungsten carbide particles include relatively smaller particles of WC bonded together by a matrix material. Cobalt and cobalt alloys are often used as matrix materials in sintered tungsten carbide particles. Sintered tungsten carbide particles can be formed by mixing together a first powder that includes the relatively smaller tungsten carbide particles and a second powder that includes cobalt particles. The powder mixture is formed in a “green” state. The green powder mixture then is sintered at a temperature near the melting temperature of the cobalt particles to form a matrix of cobalt material surrounding the tungsten carbide particles to form particles of sintered tungsten carbide. Finally, macrocrystalline tungsten carbide particles generally consist of single crystals of WC.

Various techniques known in the art may be used to apply a hardfacing material to a surface of a drill bit. In the current instance, a rod may be configured as a hollow, cylindrical tube formed from the matrix material of the hardfacing material that is filled with tungsten carbide particles. At least one end of the hollow, cylindrical tube may be sealed. The sealed end of the tube then may be melted onto the desired surface on the drill bit. As the tube melts, the tungsten carbide particles within the hollow, cylindrical tube mix with the molten matrix material as it is deposited onto the drill bit. An alternative technique involves forming a cast rod of the hardfacing material and using a torch to apply or weld hardfacing material disposed at an end of the rod to the desired surface on the drill bit.

When a hardfacing material is applied to a surface of a drill bit, relatively high temperatures are used to melt at least the matrix material. At these relatively high temperatures, atomic diffusion may occur between the tungsten carbide particles and the matrix material. In other words, after applying the hardfacing material, at least some atoms originally contained in a tungsten carbide particle (tungsten and carbon, for example) may be found in the matrix material surrounding the tungsten carbide particle. In addition, at least some atoms originally contained in the matrix material (iron, for example) may be found in the tungsten carbide particles. At least some atoms originally contained in the tungsten carbide particle (tungsten and carbon, for example) may be found in a region of the matrix material immediately surrounding the tungsten carbide particle. In addition, at least some atoms originally contained in the matrix material (iron, for example) may be found in a peripheral or outer region of the tungsten carbide particle.

Atomic diffusion between the tungsten carbide particle and the matrix material may embrittle the matrix material in the region surrounding the tungsten carbide particle and reduce the hardness of the tungsten carbide particle in the outer region thereof, reducing the overall effectiveness of the hardfacing material. There is a need in the art for methods of applying such abrasive wear-resistant hardfacing materials, and for drill bits and drilling tools that include such materials wear using a minimum of time and heat for the application of hardfacing material.

The illustrations presented herein are not meant to be actual views of any particular material, apparatus, system, or method, but are merely idealized representations which are employed to describe the present invention. Additionally, elements common between figures may retain the same numerical designation.

Corners, sharp edges, and angular projections may produce residual stresses, which may cause tungsten carbide material in the regions of the particles proximate the residual stresses to melt at lower temperatures during application of the abrasive wear-resistant material 54 to a surface of a drill bit. Melting or partial melting of the tungsten carbide material during application may facilitate atomic diffusion between the tungsten carbide particles and the surrounding matrix material.

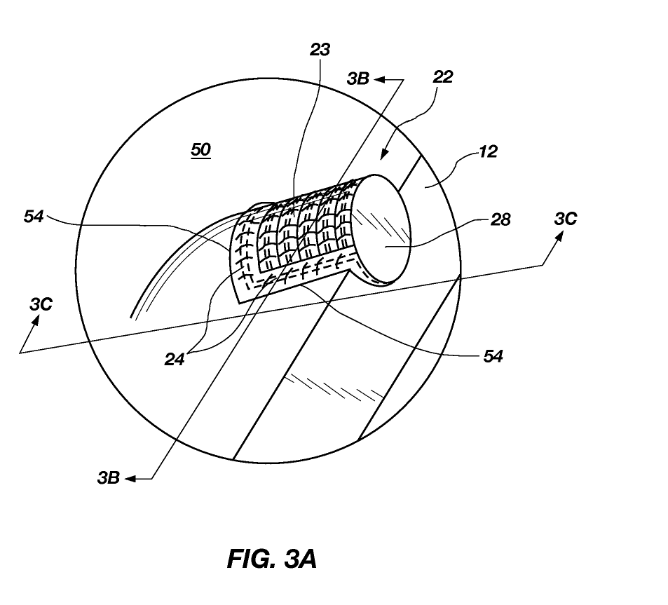

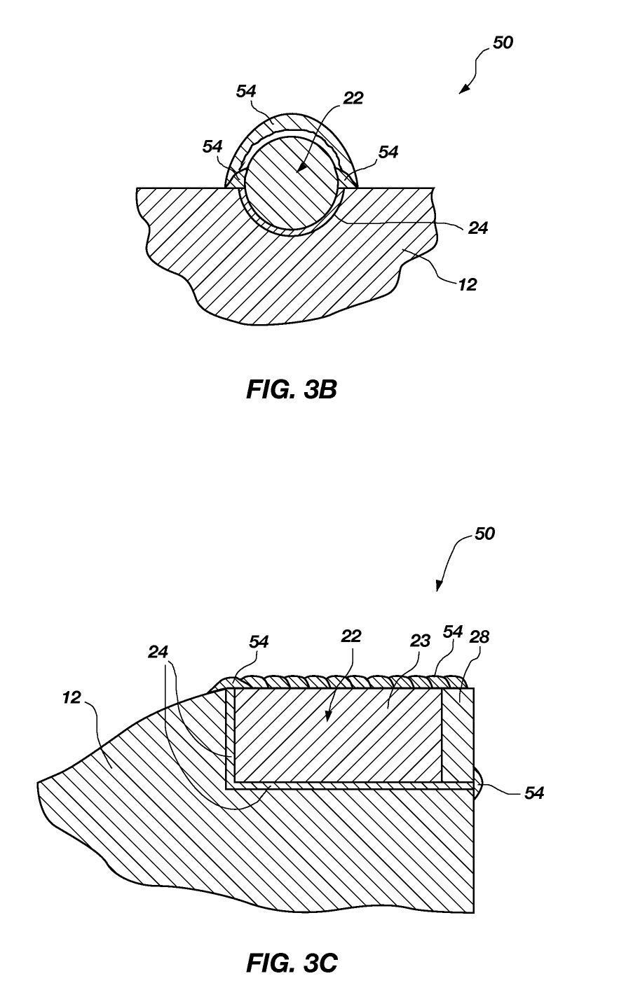

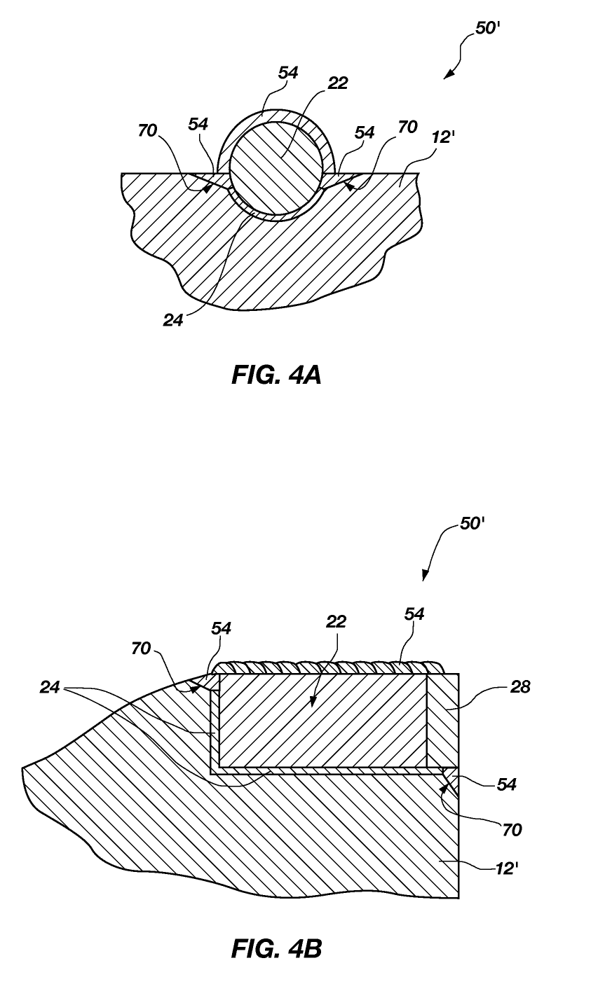

Abrasive wear-resistant materials that embody teachings of the present invention, such as the abrasive wear-resistant material 54 illustrated in FIGS. 3A-3C and 4A and 4B, may be applied to selected areas on surfaces of rotary drill bits (such as the rotary drill bit 10 shown in FIG. 1), rolling cutter drill bits (commonly referred to as “roller cone” drill bits), and other drilling tools that are subjected to wear such as ream-while-drilling tools and expandable reamer blades, all such apparatuses and others being encompassed, as previously indicated, within the term “drill bit.”

Certain locations on a surface of a drill bit may require relatively higher hardness, while other locations on the surface of the drill bit may require relatively higher fracture toughness. In addition to being applied to selected areas on surfaces of drill bits and drilling tools that are subjected to wear, the abrasive wear-resistant materials that embody teachings of the present invention may be used to protect structural features or materials of drill bits and drilling tools that are relatively more prone to wear.

A portion of a representative rotary drill bit 50 that embodies teachings of an embodiment is shown in FIG. 3A. The rotary drill bit 50 is structurally similar to the rotary drill bit 10 shown in FIG. 1, and includes a plurality of cutting elements 22 positioned and secured within pockets provided on the outer surface of a bit body 12. As illustrated in FIG. 3A, each cutting element 22 may be secured to the bit body 12 of the drill bit 50 along an interface therebetween. A bonding material 24 such as, for example, an adhesive or brazing alloy may be provided at the interface and used to secure and attach each cutting element 22 to the bit body 12. The bonding material 24 may be less resistant to wear than the materials of the bit body 12 and the cutting elements 22. Each cutting element 22 may include a polycrystalline diamond compact table 28 attached and secured to a cutting element body or substrate 23 along an interface.

The rotary drill bit 50 further includes an abrasive wear-resistant material 54 disposed on a surface of the drill bit 50. Moreover, regions of the abrasive wear-resistant material 54 may be configured to protect exposed surfaces of the bonding material 24.

FIG. 3B is a lateral cross-sectional view of the cutting element 22 shown in FIG. 3A taken along section line 3B-3B therein. As illustrated in FIG. 3B, continuous portions of the abrasive wear-resistant material 54 may be bonded both to a region of the outer surface of the bit body 12 and a lateral surface of the cutting element 22 and each continuous portion may extend over at least a portion of the interface between the bit body 12 and the lateral sides of the cutting element 22.

FIG. 3C is a longitudinal cross-sectional view of the cutting element 22 shown in FIG. 3A taken along section line 3C-3C therein. As illustrated in FIG. 3C, another continuous portion of the abrasive wear-resistant material 54 may be bonded both to a region of the outer surface of the bit body 12 and a longitudinal surface of the cutting element 22 and may extend over at least a portion of the interface between the bit body 12 and the longitudinal end surface of the cutting element 22 opposite the polycrystalline diamond compact table 28. Yet another continuous portion of the abrasive wear-resistant material 54 may be bonded both to a region of the outer surface of the bit body 12 and a portion of the exposed surface of the polycrystalline diamond compact table 28 and may extend over at least a portion of the interface between the bit body 12 and the face of the polycrystalline diamond compact table 28.

In this configuration, the continuous portions of the abrasive wear-resistant material 54 may cover and protect at least a portion of the bonding material 24 disposed between the cutting element 22 and the bit body 12 from wear during drilling operations. By protecting the bonding material 24 from wear during drilling operations, the abrasive wear-resistant material 54 helps to prevent separation of the cutting element 22 from the bit body 12 during drilling operations, damage to the bit body 12, and catastrophic failure of the rotary drill bit 50.

The continuous portions of the abrasive wear-resistant material 54 that cover and protect exposed surfaces of the bonding material 24 may be configured as a bead or beads of abrasive wear-resistant material 54 provided along and over the edges of the interfacing surfaces of the bit body 12 and the cutting element 22.

A lateral cross-sectional view of a cutting element 22 of another representative rotary drill bit 50′ that embodies teachings of the present invention is shown in FIGS. 4A and 4B. The rotary drill bit 50′ is structurally similar to the conventional rotary drill bit 10 shown in FIG. 1, and includes a plurality of cutting elements 22 positioned and secured within pockets provided on the outer surface of a bit body 12′. The cutting elements 22 of the rotary drill bit 50′ also include continuous portions of the abrasive wear-resistant material 54 that cover and protect exposed surfaces of a bonding material 24 along the edges of the interfacing surfaces of the bit body 12′ and the cutting element 22, as discussed previously herein in relation to the rotary drill bit 50 shown in FIGS. 3A-3C.

As illustrated in FIG. 4A, however, recesses 70 are provided in the outer surface of the bit body 12′ adjacent pockets within which the cutting elements 22 are secured. In this configuration, a bead or beads of abrasive wear-resistant material 54 may be provided within the recesses 70 along the edges of the interfacing surfaces of the bit body 12 and the cutting element 22. By providing the bead or beads of abrasive wear-resistant material 54 within the recesses 70, the extent to which the bead or beads of abrasive wear-resistant material 54 protrude from the surface of the rotary drill bit 50′ may be minimized. As a result, abrasive and erosive materials and flows to which the bead or beads of abrasive wear-resistant material 54 are subjected during drilling operations may be reduced.

The abrasive wear-resistant material 54 may be used to cover and protect interfaces between any two structures or features of a drill bit or other drilling tool. For example, abrasive wear-resistant material 54 may cover and protect the interface between a bit body and a periphery of wear knots or any type of insert in the bit body. In addition, the abrasive wear-resistant material 54 is not limited to use at interfaces between structures or features and may be used at any location on any surface of a drill bit or drilling tool that is subjected to wear.

Abrasive wear-resistant materials, such as the abrasive wear-resistant material 54, may be applied to the selected surfaces of a drill bit or drilling tool using variations of techniques known in the art. For example, a pre-application abrasive wear-resistant material that embodies teachings of the present invention may be provided in the form of a rod, such as a KUTRITE® rod, sold by M&M metals, Houston, Tex. The rod may comprise a solid cast or extruded rod consisting of the abrasive wear-resistant material 54. Alternatively, the rod may comprise a hollow cylindrical tube formed from a matrix material and filled with a plurality of sintered tungsten carbide pellets and a plurality of cast tungsten carbide granules. An oxyacetylene torch or any other type of welding torch may be used to heat at least a portion of the welding rod to a temperature above the melting point of the matrix material 60 and less than about 1200° C. to melt the matrix material. This may minimize the extent of atomic diffusion occurring between the matrix material and either the sintered tungsten carbide, cast tungsten carbide or macrocrystalline tungsten carbide.

The rate of atomic diffusion occurring between the matrix material and either the sintered tungsten carbide, cast tungsten carbide, or macrocrystalline tungsten carbide is at least partially a function of the temperature at which atomic diffusion occurs. The extent of atomic diffusion, therefore, is at least partially a function of both the temperature at which atomic diffusion occurs and the time for which atomic diffusion is allowed to occur. Therefore, the extent of atomic diffusion occurring between the matrix material and either the sintered tungsten carbide, cast tungsten carbide, or macrocrystalline tungsten carbide may be controlled by controlling the distance between the torch and the rod (or pre-application abrasive wear-resistant material), and the time for which the rod is subjected to heat produced by the torch.

Oxyacetylene and atomic hydrogen torches may be capable of heating materials to temperatures in excess of 1200° C. It may be beneficial to slightly melt the surface of the drill bit or drilling tool to which the abrasive wear-resistant material 54 is to be applied just prior to applying the abrasive wear-resistant material 54 to the surface. For example, an oxyacetylene and atomic hydrogen torch may be brought in close proximity to a surface of a drill bit or drilling tool and used to heat to the surface to a sufficiently high temperature to slightly melt or “sweat” the surface. The rod comprising pre-application wear-resistant material then may be brought in close proximity to the surface and the distance between the torch and the welding rod may be adjusted to heat at least a portion of the welding rod to a temperature above the melting point of the matrix material and less than about 1200° C. to melt the matrix material. The molten matrix material, at least some of either the sintered tungsten carbide, cast tungsten carbide, or macrocrystalline tungsten carbide may be applied to the surface of the drill bit, and the molten matrix material may be solidified by controlled cooling. The rate of cooling may be controlled to control the microstructure and physical properties of the abrasive wear-resistant material 54.

Alternatively, the abrasive wear-resistant material 54 may be applied to a surface of a drill bit or drilling tool using oxyacetylene and an atomic hydrogen torches, arc to maintain the bonding material 24 in a molten liquidus state or plastic molten state with the application of either the sintered tungsten carbide, cast tungsten carbide, or macrocrystalline tungsten carbide in a powder state being applied thereto through the use of gas under pressure, such as by blowing the powder into the bonding material 24. For example, the matrix material may be provided in the form of a powder having either the sintered tungsten carbide, cast tungsten carbide, or macrocrystalline tungsten carbide as a powder mixed with the powdered matrix material to provide a pre-application wear-resistant material in the form of a powder mixture.

As the powdered pre-application wear-resistant material passes through the torch it is heated to a temperature at which at least some of the wear-resistant material will melt and mix with or be embedded in the bonding material 24. Once the at least partially molten wear-resistant material has been deposited on the surface of the substrate, the wear-resistant material is allowed to solidify.

The temperature to which the pre-application wear-resistant material is heated as the material passes through the torch may be at least partially controlled by suitable manners known in the art to 1200° C. or less to heat at least a portion of the pre-application wear-resistant material to a temperature above the melting point of the matrix material 60 and less than about 1200° C. to melt the matrix material. This may minimize the extent of atomic diffusion occurring between the matrix material and either the sintered tungsten carbide, cast tungsten carbide, or macrocrystalline tungsten carbide.

Arc welding, metal inert gas (MIG) arc welding techniques, tungsten inert gas (TIG) arc welding techniques, and flame spray welding techniques are known in the art and may be used to apply the abrasive wear-resistant material 54 to a surface of a drill bit or drilling tool.

The present embodiments herein have been described herein with respect to certain preferred embodiments, those of ordinary skill in the art will recognize and appreciate that it is not so limited. Rather, many additions, deletions and modifications to the preferred embodiments may be made without departing from the scope of the invention as hereinafter claimed. In addition, features from one embodiment may be combined with features of another embodiment while still being encompassed within the scope of the embodiments as contemplated by the inventors. Further, the embodiments herein have utility in drill bits and core bits having different and various bit profiles as well as cutter types.

1. A device for use in drilling subterranean formations, the device comprising:
a first structure;
a second structure secured to the first structure along an interface;
a bonding material disposed between the first structure and the second structure at the interface, the bonding material securing the first structure and the second structure together; and
an abrasive wear-resistant material disposed on a surface of the device, at least a continuous portion of the wear-resistant material being bonded to a surface of the first structure and a surface of the second structure and extending over the interface between the first structure and the second structure and covering the bonding material, a portion of the abrasive wear-resistant material embedded within a portion of the bonding material.

2. The device of claim 1, wherein the first structure comprises a drill bit, the second structure comprises a cutting element, and the bonding material comprises a brazing alloy.

3. The device of claim 1, wherein the device further comprises a bit body having an outer surface, the bit body comprising at least one recess formed in the outer surface adjacent the interface between the drill bit and the cutting element, at least a portion of the abrasive wear-resistant material being disposed within the at least one recess.

4. The device of claim 1, wherein the device further comprises a bit body having an outer surface and a pocket therein, at least a portion of the cutting element being disposed within the pocket, the interface extending along adjacent surfaces of the bit body and the cutting element.

5. The device of claim 1, wherein a matrix material of the abrasive wear-resistant material comprises one of sintered tungsten carbide, cast tungsten carbide, and macrocrystalline tungsten carbide.

6. A rotary drill bit for use in drilling comprising:
a first structure forming a portion of the rotary drill bit;
a second structure secured to the first structure along an interface;
a bonding material disposed between the first structure and the second structure at the interface, the bonding material securing the first structure and the second structure together; and
an abrasive wear-resistant material disposed on a surface of the rotary drill bit, at least a continuous portion of the wear-resistant material being bonded to a surface of the first structure and a surface of the second structure and extending over the interface between the first structure and the second structure and covering the bonding material, a portion of the abrasive wear-resistant material embedding within a portion of the bonding material.

7. The rotary drill bit of claim 6, wherein the first structure comprises a blade on the rotary drill bit and the second structure comprises a cutting element.

8. The rotary drill bit of claim 6, wherein the bonding material comprises a brazing alloy.

9. The rotary drill bit of claim 6, wherein the rotary drill bit further comprises a bit body having an outer surface, the bit body comprising at least one recess formed in the outer surface adjacent the interface between the drill bit and the cutting element, at least a portion of the abrasive wear-resistant material being disposed within the at least one recess.

10. The rotary drill bit of claim 6, wherein the rotary drill bit further comprises a bit body having an outer surface and a pocket therein, at least a portion of the cutting element being disposed within the pocket, the interface extending along adjacent surfaces of the bit body and the cutting element.

11. The rotary drill bit of claim 6, wherein a recess is formed along a portion of the second structure having abrasive wear-resistant material located therein.

12. The rotary drill bit of claim 6, further comprising a recess formed adjacent a portion of the second structure having abrasive wear-resistant material located therein.

13. The rotary drill bit of claim 6, further comprising a recess formed adjacent a portion of two sides of the second structure, the at least one recess having abrasive wear-resistant material located therein.

14. A method for applying an abrasive wear-resistant material to a surface of a drill bit having an outer surface for drilling subterranean formations, the method comprising:
providing a mixture of a matrix material and one of sintered tungsten carbide, cast tungsten carbide, and macrocrystalline tungsten, the matrix material having a melting point of less than about 1100° C.;
melting the matrix material, melting the matrix material comprising heating at least a portion of the pre-application abrasive wear-resistant material to a temperature above the melting point of the matrix material and less than about 1100° C. to melt the matrix material;
applying the molten matrix material, at least some of one of the sintered tungsten carbide, and at least some of one of the cast tungsten carbide, to at least a portion of the outer surface of the drill bit having a portion thereof in one of a molten state or plastic state; and
solidifying the molten matrix material.

15. The method of claim 14, wherein heating the matrix material comprises burning acetylene in substantially pure oxygen to heat the matrix material.

16. The method of claim 14, wherein providing a drill bit comprises providing a drill bit comprising:
a bit body;
at least one cutting element secured to the bit body along an interface; and
a brazing alloy disposed between the bit body and the at least one cutting element at the interface, the brazing alloy securing the at least one cutting element to the bit body.

17. The method of claim 14, wherein providing a drill bit comprises providing a drill bit comprising:
a bit body having an outer surface and a pocket therein;
at least one cutting element secured to the bit body along an interface, at least a portion of the at least one cutting element being disposed within the pocket, the interface extending along adjacent surfaces of the bit body and the at least one cutting element.

18. The method of claim 14, wherein providing a drill bit comprises providing a drill bit comprising a bit body having an outer surface, the bit body comprising at least one recess formed in the outer surface adjacent the at least one cutting element, and wherein applying the molten matrix material, at least some of one of the sintered tungsten carbide, cast tungsten carbide, and macrocrystalline tungsten to at least a portion of the outer surface of the drill bit comprises applying the molten matrix material, at least some of one of the sintered tungsten carbide, cast tungsten carbide, and macrocrystalline tungsten to the outer surface within the at least one recess.

19. The method of claim 14, wherein applying the molten matrix material, at least some of one of the sintered tungsten carbide, cast tungsten carbide, and macrocrystalline tungsten to at least a portion of the outer surface of the drill bit comprises applying the molten matrix material, at least some of one of the sintered tungsten carbide, cast tungsten carbide, and macrocrystalline tungsten to exposed surfaces of the brazing alloy at an interface between the bit body and the at least one cutting element.

20. A method for securing a cutting element to a bit body of a rotary drill bit, the bit body having an outer surface and a pocket therein, the method comprising:
positioning a portion of a cutting element within a pocket in the outer surface of the bit body;
providing a brazing alloy;
melting the brazing alloy;
applying molten brazing alloy to an interface between the cutting element and the outer surface of the bit body; and
applying an abrasive wear-resistant material to a surface of the rotary drill bit, at least a continuous portion of the abrasive wear-resistant material being bonded to a surface of the cutting element and a portion of the outer surface of the bit body and extending over the interface between the cutting element and the outer surface of the bit body and imbedded into the brazing alloy.

21. The method of claim 20, further comprising forming at least one recess in the outer surface of the bit body adjacent the pocket that is configured to receive the cutting element, and wherein providing an abrasive wear-resistant material to a surface of the rotary drill bit comprises providing an abrasive wear-resistant material to the outer surface of the bit body within the at least one recess.
